(19) United States
(12) Patent Application Publication
(10) Pub. No.: US 2010/0157429 A1
(43) Pub. Date: Jun. 24, 2010

(54) Lens array, LED head, exposure device, image forming apparatus and reading apparatus

(75) Inventor: Akihiro Yamamura, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 12/654,192

(22) Filed: Dec. 14, 2009

(30) Foreign Application Priority Data
Dec. 19, 2008 (JP) 2008-324048

(51) Int. Cl. G02B 27/12

(52) U.S. Cl. 359/622

(57) ABSTRACT

A lens array includes a plurality of lens groups each of which includes a plurality of lenses arranged in a direction perpendicular to optical axes of the lenses. The lens groups are disposed so that the lenses of the respective lens groups have aligned optical axes. A light shielding member is provided between the lens groups. The light shielding member has a plurality of apertures with substantially cylindrical shapes through which the optical axes of the respective lenses pass. The light shielding member is integrally formed so as to include a plurality of the apertures.

### BACKGROUND OF THE INVENTION

The present invention relates to a lens array, an LED (Light Emitting Diode) head, an exposure device, an image forming apparatus and a reading apparatus.

Conventionally, a lens array is used in an electrophotographic image forming apparatus having an LED head with a plurality of linearly arranged LEDs, and used in a reading apparatus such as a scanner and a facsimile having a light receiving portion with a plurality of light receiving elements (which are linearly arranged) onto which an image of a manuscript is focused. Such a lens array functions as an optical system for forming an erected image of the object at a magnification of 1:1 as one-dimensional image.

The lens array can be composed of a plurality of linearly arranged microlens pairs each of which includes two microlenses having coaxial optical axes, so as to form an erected image of the object at a magnification of 1:1 as one-dimensional image. Such a lens array can be formed by injection molding of plastic material with high accuracy, so that high resolution is achieved.

In order to shield each microlens pair from light from other microlens pair, it is necessary to provide a light shielding portion between adjacent microlens pairs. The light shielding portion has openings as apertures each of which is disposed between microlenses of each microlens pair.

The openings of the light shielding portion need to be formed so that the openings are aligned with optical axes of the microlenses. In this regard, if the microlenses are arranged at a small interval, it is difficult to form such openings with high accuracy. Therefore, the Patent Document No. 1 discloses a light shielding portion having a structure split into at least two parts in which each opening is formed by a combination of at least tow parts.

Patent Document No. 1: Japanese Laid-open Patent Publication No. 2008-87175 (see, for example, paragraphs 0033-0041 and FIG. 1)

Recently, it is desired to further facilitate manufacturing of the lens array.

### SUMMARY OF THE INVENTION

The present invention is intended to facilitate manufacturing of the lens array with apertures which are aligned with optical axes of microlenses.

The present invention provides a lens array including a plurality of lens groups each of which includes a plurality of lenses arranged in a direction perpendicular to optical axes of the lenses. The lens groups are disposed so that lenses of the respective lens groups have aligned optical axes. A light shielding member is provided between the lens groups. The light shielding member has a plurality of apertures having substantially cylindrical shapes through which the optical axes of the respective lenses pass. The light shielding member is integrally formed so as to include a plurality of the apertures.

With such a configuration, the lens array having apertures aligned with optical axes of the lens groups can be manufactured in a simple manner.

Further scope of applicability of the present invention will become apparent from the detailed description given hereinafter. However, it should be understood that the detailed description and specific embodiments, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In the attached drawings:

FIG. 1 is a schematic view showing a configuration of an image forming apparatus according to the first embodiment of the present invention;

FIG. 2 is a sectional view showing an LED head according to the first embodiment of the present invention;

FIG. 3A is a plan view showing a lens plate of an lens array according to the first embodiment of the present invention;

FIG. 3B is a plan view showing a light shielding member of the lens array according to the first embodiment of the present invention;

FIG. 3C is a sectional view showing the lens array according to the first embodiment of the present invention;

FIG. 3D is an enlarged plan view showing an opening of the light shielding member according to the first embodiment of the present invention;

FIG. 4 is a schematic view showing a function of the lens array according to the first embodiment of the present invention;

FIG. 5 is a schematic view showing the function of the lens array according to the first embodiment of the present invention;

FIGS. 6A and 6B show examples of relationships between microlenses and viewing fields according to the first embodiment of the present invention;

FIGS. 7A and 7B are a perspective view and a sectional view showing a mold used to mold the light shielding member according to the first embodiment of the present invention;

FIG. 8 is a perspective view showing a die used to form the mold for forming the light-locking member according to the first embodiment of the present invention;

FIGS. 9A, 9B and 9C are sectional views for illustrating a manufacturing method of the mold for forming the light shielding member according to the first embodiment of the present invention;

FIG. 10 shows an evaluation pattern used for evaluating an image forming apparatus according to the first embodiment of the present invention;

FIGS. 11A and 11B are a plan view and a sectional view showing a light shielding member of a lens array according to the second embodiment of the present invention;

FIG. 11C is an enlarged plan view showing an opening of the light shielding member of the lens array according to the second embodiment of the present invention;

FIGS. 12A and 12B show a function of the lens array according to the second embodiment of the present invention;

FIG. 13 is a perspective view showing a mold used to form the light shielding member according to the second embodiment of the present invention;

FIG. 14 is a perspective view showing a die used to form the mold for forming the light shielding member according to the second embodiment of the present invention;

FIG. 15 is a schematic view showing a reading apparatus according to the third embodiment of the present invention;

FIG. 16A is a schematic view showing a reading head of the reading apparatus according to the third embodiment of the present invention;

FIG. 16B is a schematic view showing a function of a lens array of the reading head according to the third embodiment of the present invention;

FIG. 17 is an exploded perspective view showing a light shielding member of a lens array according to the fourth embodiment of the present invention, and

FIG. 18 is a plan view showing the light shielding member according to the fourth embodiment of the present invention.

### DETAILED DESCRIPTION OF THE PREFERRED EMBODIMENT

Hereinafter, embodiments of a lens array, an LED head, an exposure device, an image forming apparatus and a reading apparatus according to the present invention will be described with reference to the attached drawings.

### First Embodiment

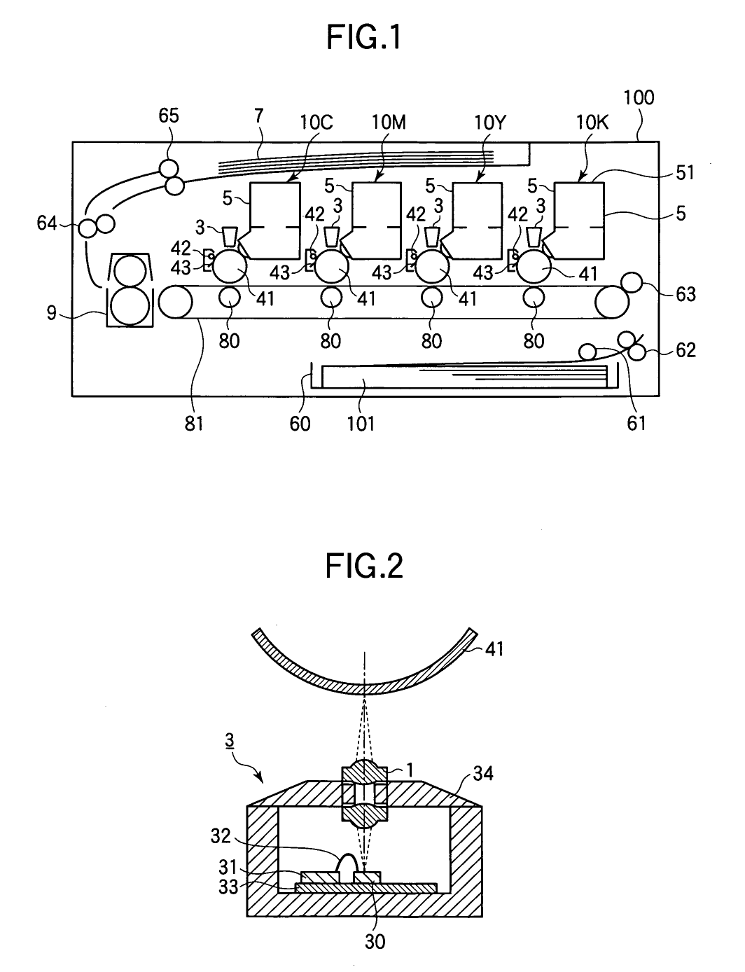

FIG. 1 is a schematic view showing a printer as an image forming apparatus according to the first embodiment of the present invention.

In FIG. 1, the printer 100 is configured to form an image on a printing medium based on image data using a toner formed of resin containing pigment as a coloring agent. The printer 100 includes a sheet cassette 60 in which sheets 101 (as printing media) are stored, a feeding roller 61 that feeds the respective sheet 101 out of the sheet cassette 60 and carrying rollers 62 and 63 that carry the sheet 101 along a feeding path.

The printer 100 of this embodiment is a color electrophotographic printer, and includes image forming portions 10K, 10Y, 10M and 10C for forming images of black, yellow, magenta and cyan. The image forming portions 10K, 10Y, 10M and 10C have the same configurations, and arranged along the feeding path of the sheet 101. Each of the image forming portions 10K, 10Y, 10M and 10C includes a photosensitive drum 41 as a latent image bearing body, a charging roller 42 that applies electric charge to the surface of the photosensitive drum 41 to uniformly charge the surface of the photosensitive drum 41, an LED head 3 as an exposure device that exposes the surface of the photosensitive drum 41 based on image data to form a latent image, a developing unit 5 that develops the latent image on the photosensitive drum 41 using the toner to form a toner image, and a toner cartridge 51 that supplies the toner to the developing unit 5.

Each of the image forming portions 10K, 10Y, 10M and 10C further includes a transfer roller 80 facing the photosensitive drum 41 for transferring the toner image from the photosensitive drum 41 to the sheet 101, a transfer belt 81 sandwiched between the transfer roller 80 and the photosensitive drum 41 at a transfer portion, and a cleaning blade 43 disposed contacting the surface of the photosensitive drum 41 for removing the residual toner remaining on the surface of the photosensitive drum 41 after the toner passes the transfer portion.

A fixing unit 9 is disposed on the downstream side (i.e., the left side in FIG. 1) of the image forming portions 10K, 10Y, 10M and 10C. The fixing unit 9 fixes the toner image to the sheet 101 by applying heat and pressure. Carrying rollers 64 are disposed on the downstream side of the fixing unit 9, which carry the sheet 101 having passed the fixing unit 9. Ejection rollers 65 are disposed on the downstream side of the carrying rollers 64, which eject the sheet 101 (on which the image has been fixed) to a stacker portion 7 for stacking the sheets 101.

The charging rollers 42 and the transfer rollers 80 are applied with predetermined voltages by not shown power sources. The transfer belt 81, the photosensitive drums and the respective rollers are driven by not shown motors and gears that transmit driving forces of the motors. The developing units 5, the LED heads 3, the fixing unit 9 and not shown motors are connected to power sources and a control unit.

The printer 100 includes an external interface for receiving print data from external devices, and is configured to form an image on the sheet 101 based on the print data received via the external interface. The printer 100 further includes a storage portion such as a memory in which a control program is stored, and a control portion as a controlling unit or arithmetic unit that controls an entire operation of the printer 100 according to the control program.

Next, a configuration of an LED head 3 according to the first embodiment of the present invention will be described with reference to FIG. 2.

FIG. 2 is a sectional view schematically showing the LED head 3 as the exposure device. In FIG. 2, the LED head 3 has a lens array 1 and a lens holder 34 to which the lens array 1 is fixed. A circuit board 33 is held by the holder 34 so as to face the lens array 1. LED elements 30 as a light emitting portion and a driver IC 31 are provided on the circuit board 33. The LED elements 30 and the driver IC 31 are connected to each other using wires 32. The LED elements 30 are driven by the driver IC 31 to emit lights. The LED elements 30 are linearly arranged in a row with a predetermined arranging interval PD (mm). The arranging direction of the LED elements 30 is parallel to a rotation axis of the photosensitive drum 41.

The lens array 1 focuses images of the LED elements 30 onto the surface of the photosensitive drum 41. The LED elements 30 are driven to emit lights in accordance with the rotation of the photosensitive drum 41, so that a latent image is formed on the surface of the photosensitive drum 41.

In this embodiment, the LED head 3 has a resolution of 600 dpi (dots per inch). In other words, 600 LED elements 30 are arranged per inch (1 inch is approximately 25.4 mm). Therefore, the arranging interval PD of the LED elements 30 is 0.0423 mm.

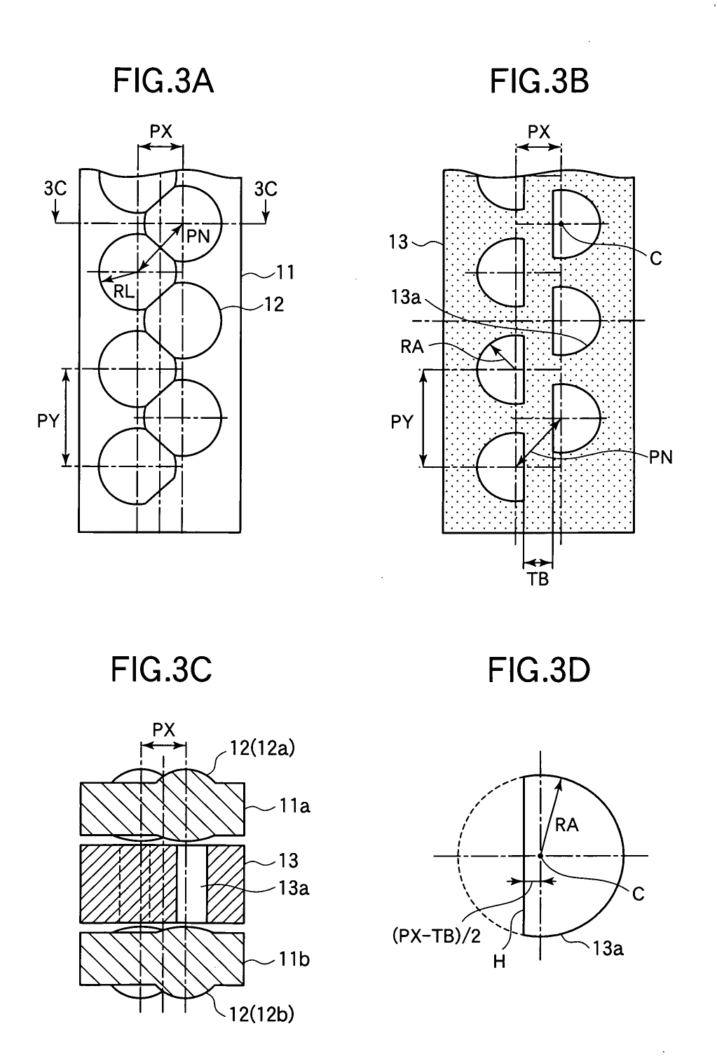

Next, a lens plate and a light shielding member of the lens array 1 according to the first embodiment will be described. FIG. 3A is a plan view showing a lens plate 11 of the lens array 1 according to the first embodiment. FIG. 3B is a plan view showing a light shielding member 13 of the lens array 1 according to the first embodiment. FIG. 3C is a sectional view of the lens array 1 taken along line 3C-3C in FIG. 3A. FIG. 3D is an enlarged plan view showing an opening 13a of the light shielding member 13.

In FIGS. 3A and 3C, the lens array 1 includes two lens plates 11a and 11b (i.e., lens groups) and the light shielding member 13. Each of the lens plates 11a and 11b includes a plurality of microlenses 12 (i.e., lens elements) arranged in two rows in a direction perpendicular to optical axes of the microlenses 12. The optical axes of the microlenses 12 of the lens plate 11a are aligned with the optical axes of the microlenses 12 of the lens plate 11b.

In FIG. 3A, the microlenses 12 of the lens plate 11a (11b) are arranged in two rows parallel to each other, and the microlenses 12 are arranged at intervals PY (i.e., arranging intervals) in each row. An interval between two rows (in a direction perpendicular to the arranging direction of the microlenses 12) is expressed as PX. In this embodiment, PY>PX is satisfied.

Each microlens 12 has a radius expressed as RL. A center-to-center distance between one microlens 12 of one row and the closest microlens 12 of the other row is expressed as PN. The microlenses 12 are so disposed that the microlenses 12 of the adjacent rows partially overlap with each other. That is, PN<2×RL is satisfied. Each microlens 12 has a circular shape with a cutout portion formed at a position where the microlens 12 contacts the adjacent microlens 12. The lens plates 11a and 11b are composed of a material that transmits the light emitted by the light emitting portion (i.e., the LED element 30).

The light shielding member 13 is inserted between the lens plates 11a and 11b as shown in FIG. 3C. In FIG. 3B, the light shielding member 13 is composed of a black resin or the like that blocks the light from the light emitting portion (i.e., the LED element 30). The light shielding member 13 has openings 13a (i.e., through-holes) as apertures corresponding to the microlenses 12 of the first and second lens plates 11a and 11b. The microlenses 12 are arranged in two rows. An arranging interval PY of the openings 13a (i.e., a center-to-center distance of the openings 13a) in each row is the same as the arranging interval PY of the microlenses 12. An interval PX between two rows of the openings 13a in a direction perpendicular to the arranging direction of the microlenses 12 is the same as the interval PX between two rows of the microlenses 12. A center-to-center distance between one opening 13a of one row and the closest opening 13a of the other row is expressed as PN.

Center axes “C” of cylindrical parts of the openings 13a are aligned with the optical axes of the microlenses 12. A radius RA from the center axis to an arc of the opening 13a is smaller than the radius RL of the microlens 12.

The openings 13a are disposed so that a distance TB (in a direction perpendicular to the arranging direction of the microlenses 12) is formed between two rows. As shown in FIG. 3D, each opening 13a has a cylindrical shape having a radius RA which is cut by a plane H substantially parallel to the arranging direction of the microlenses 12 at a distance of (PX−TB)/2 from the center axis C of the cylindrical part of the opening 13a. In other words, in a cross section perpendicular to the optical axes of the microlenses 12, each opening 13a has a circular shape with a cutout portion.

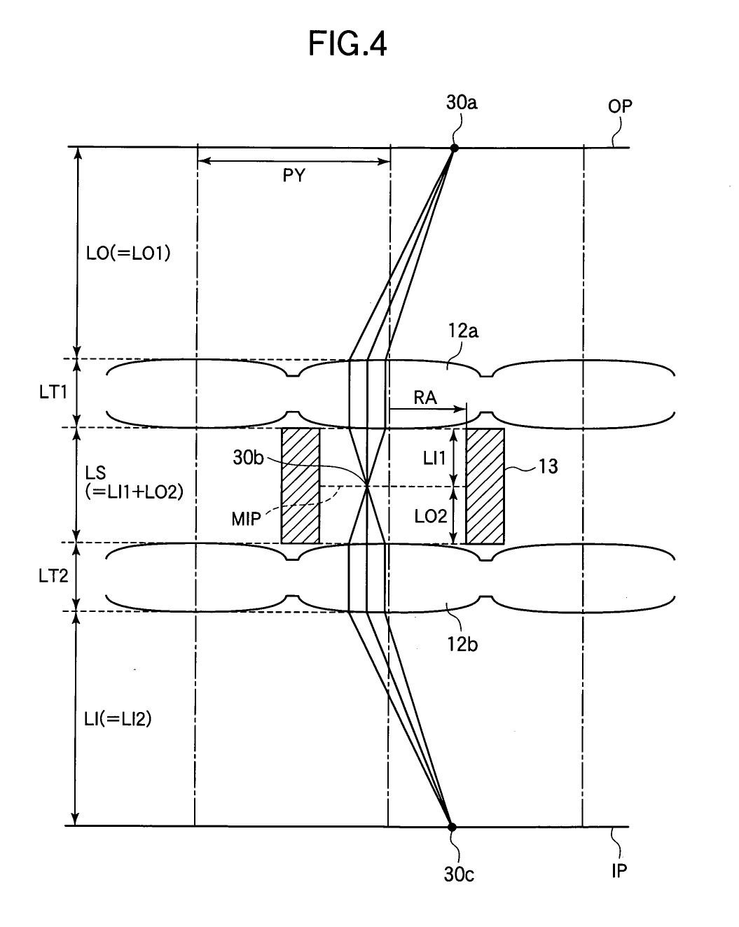

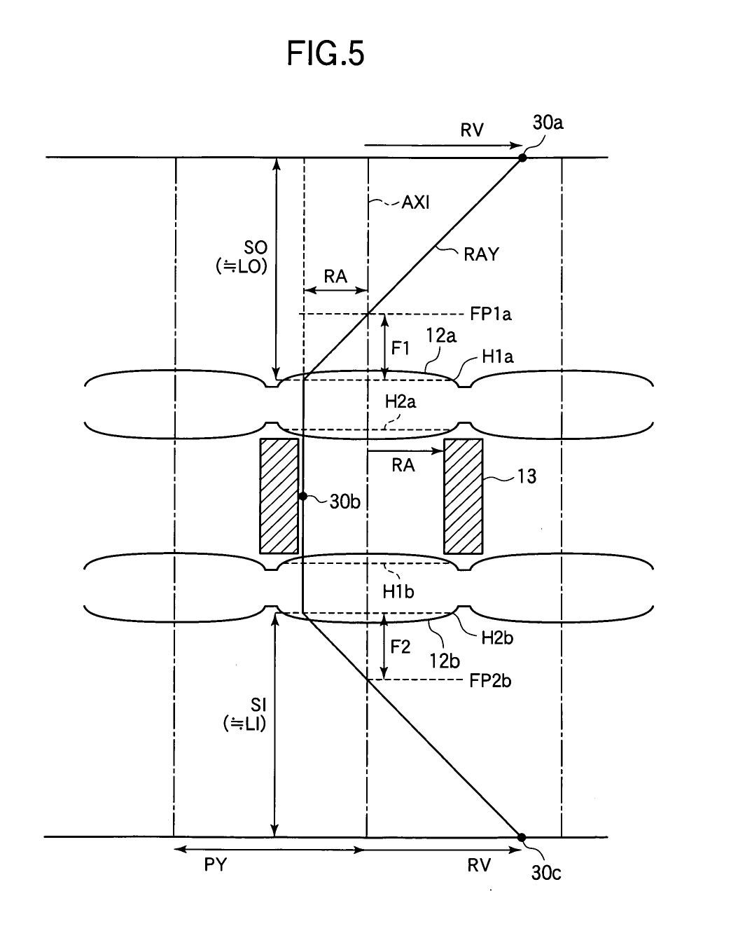

The configuration of the lens array 1 will be described with reference to FIG. 4. FIG. 4 is a sectional view of the lens array 1 cut along a plane including the optical axes of the microlenses 12 and substantially parallel to the arranging direction of the microlenses 12. In FIG. 4, a left-right direction is parallel to the arranging direction of the microlenses 12.

In FIG. 4, the first microlenses 12a (i.e., microlenses 12 of the lens plate 11a) are disposed at a distance LO from the object plane OP of the lens array 1. The second microlenses 12b (i.e., microlenses 12 of the lens plate 11b) are disposed facing the first microlenses 12a so that optical axes of the second microlenses 12b are aligned with optical axes of the first microlenses 12a, and are disposed at a distance LS from the first microlenses 12a. An imaging plane IP of the lens array 1 is defined at a distance LI from the second microlenses 12b in the direction of the optical axes thereof.

Each first microlens 12a has a thickness LT1 and a focal length F1. The first microlens 12a focuses an image of an object (at a distance LO1 from the first microlens 12a) onto a plane at a distance LI1 from the first microlens 12a in the direction of the optical axis thereof.

Each second microlens 12b has a thickness LT2 and a back focal length F2. The second microlens 12b focuses an image of an object (at a distance LO2 from the second microlens 12b) onto a plane at a distance LI2 from the second microlens 12b in the direction of the optical axis thereof.

The distance LO from the object plane OP of the lens array 1 to the first microlens 12a is set to be the same as LO1. The distance LS between the first and second microlenses 12a and 12b is set to be the same as the sum of the distances LI1 and LO2 (i.e., LS=LI1+LO2). The distance LI from the second microlens 12b to the imaging plane IP of the lens array 1 is set to be the same as LI2.

The first microlens 12a and the second microlens 12b can be formed to have the same configurations. In such a case, each of the microlenses 12a and 12b has the thickness LT1 and the front focal length F1. When each of the microlenses 12a and 12b focuses an image of the object at a distance LO1 onto a plane at a distance LI1 in the direction of the optical axes, the distance LO from the object plane OP of the lens array 1 to the first microlens 12a is set to be the same as the distance LO1, and the distance LS between the first and second microlenses 12a and 12b is set to be the same as double the thickness LI1 (LS=2×LI1). Further, the first and second microlenses 12a and 12b are disposed facing each other so that the curved surface of the first microlens 12a on the object plane OP side has the same shape as the curved surface of the second microlens 12b on the imaging plane IP side. The distance from the second microlens 12b to the imaging plane IP of the lens array 1 is set to be same as the distance LO1 (i.e., LI=LO).

In the above configured lens array 1, the first and second lens plates 11a and 11b are disposed on both sides of the light shielding member 13 and are oppositely oriented with respect to each other. Further, the first and second lens plates 11a and 11b are distanced from each other so as to form an image on the imaging plane IP. The first and second microlenses 12a and 12b are in conjugate positions, and the optical axes of the first and second microlenses 12a and 12b are aligned with each other, so that an optical system forming an erected image at a magnification of 1:1 is formed. The optical system (including first and second microlenses 12a and 12b having aligned optical axes) forms the erected image of the LED element 30 on the surface of the photosensitive drum 41 at a magnification of 1:1.

The light shielding member 13 is provided between the first and second lens plates 11a and 11b, and shields each optical system formed of two microlenses 12a and 12b from stray light (i.e., part of the light) from other optical systems. Further, the light shielding member 13 prevents each optical system from emitting stray lights that may enter into other optical systems.

The lens plates 11a and 11b are composed of optical plastic of cyclo-olefin polymer “ZEONEX E48R” (trademark) manufactured by ZEON Corp. Each of the lens plates 11a and 11b is formed as an integral body with a plurality of microlenses 12 using an injection molding.

A high resolution is achieved when a curved surface of each microlens 12 is a rotationally symmetrical high-order aspheric surface expressed by the following equation (1):

$$z ( r ) = \frac{\frac{{r}^{2}}{C}}{1 + \sqrt{1 - {( \frac{r}{C} )}^{2}}} + {Ar}^{4} + {Br}^{6} \qquad ( 1 )$$

In the equation (1), the function “z(r)” represents a rotational coordinate whose center axis is defined in substantially parallel to the optical axis of the microlens 12, and “r” represents a coordinate in a radial direction. The apex of the curved surface of the microlens 12 is a point of origin. The direction from the object plane toward the imaging plane of the lens array 1 is expressed by positive value. “C” represents a radius of curvature, “A” represents a fourth-order aspheric coefficient, and “B” represents a sixth-order aspheric coefficient.

Next, operations of the above described configuration of the first embodiment will be described. First, an operation of the printer 100 as an image forming apparatus will be described with reference to FIG. 1.

In FIG. 1, when the printing operation is started, the surface of the photosensitive drum 41 is uniformly charged by the charging roller 42 which is applied with a voltage by a not shown power source. When the charged surface of the photosensitive drum 41 reaches a position facing the LED head 3 by the rotation of the photosensitive drum 41, the surface of the photosensitive drum 41 is exposed to the light emitted by the LED head 3, so that a latent image is formed thereon. The latent image is developed by the developing unit 5, so that a toner image is formed on the photosensitive drum 41.

The sheet 101 stored in the sheet cassette 60 is fed out of the sheet cassette 60 by the feeding roller 61, and carried by the carrying rollers 62 and 63 to the transfer roller 80 and the transfer belt 81. When the toner image on the surface of the photosensitive drum 41 reaches to the vicinity of the transfer roller 80 and the transfer belt 81 by the rotation of the photosensitive drum 41, the toner image is transferred to the sheet 101 by the transfer roller 80 and the transfer belt 81 applied with voltages by not shown power sources.

The toner images of respective colors are transferred to the sheet 101 at the respective image forming portions 10K, 10Y, 10M and 10C, and the sheet 101 is fed to the fixing unit 9 by the transfer belt 81. The fixing unit 9 applies heat and pressure to the toner image, so that the toner image is molten and is fixed to the sheet 101. Further, the sheet 101 is fed by the carrying rollers 64 and the ejection rollers 65 to the stacker portion 7, and the printing operation of the electrophotographic printer 100 is completed.

Next, an operation of the LED head 3 according to the first embodiment will be described with reference FIG. 2. In FIG. 2, the control unit (not shown) of the printer 100 sends a control signal to the driver IC 31 according to the image data. Based on the control signal, the driver IC 31 drives the LED elements 30 to emit lights. The lights emitted by the LED elements 30 are incident on the lens array 1, and are focused onto the surface of the photosensitive drum 41.

Next, a function of the lens array 1 will be described with reference to FIG. 4. In FIG. 4, the light emitted by the LED element 30 (i.e., an object 30a) is incident on the first microlens 12a. The first microlens 12a forms an intermediate image 30b on an intermediate imaging plane MIP at a distance LI1 from the first microlens 12a in the direction of the optical axis. Further, the second microlens 12b forms an image 30c of the intermediate image 30b, with the result that the image of the LED element 30 is formed on the imaging plane IP. The image 30c is an erected image of the object 30a at the magnification of 1:1.

In this regard, the intermediate image 30b formed by the first microlens 12a is an inverted and reduced image of the object 30a. The image 30c formed on the imaging plane IP is an inverted and enlarged image of the intermediate image 30b.

Further, between the first and second microlenses 12a and 12b, principal rays of lights from respective points on the object plane OP are substantially parallel to each other (i.e., telecentric).

With such a configuration, the lens array 1 forms the erected image of the LED element 30 at the magnification of 1:1. Among the lights emitted by the first microlens 12a, non-image-forming lights (that do not contribute to formation of an image) are blocked by the light shielding member 13.

In this regard, even when the first microlens 12a and the second microlens 12b have the same configurations, the lens array 1 forms an erected image of the LED element 30 at the magnification of 1:1. In this case, the light emitted by the LED element 30 (the object 30a) is incident on the first microlens 12a, and the first microlens 12a forms the intermediate image 30b on the intermediate imaging plane MIP at a distance LS/2 from the first microlens 12a in the direction of the optical axis. The second microlens 12b forms the image 30c of the intermediate image 30b. The image 30c is an erected image of the LED element 30 at the magnification of 1:1. Between the first and second microlenses 12a and 12b, principal rays of the lights from respective points on the object plane OP are substantially parallel to each other (i.e., telecentric). As such, even when the first microlens 12a and the second microlens 12b have the same configurations, the lens array 1 forms the erected image of the LED element 30 at the magnification of 1:1. Next, optical properties of the microlens 12 will be described with reference to FIG. 5. FIG. 5 is a sectional view of the lens array 1 cut along a plane including the optical axes of the microlenses 12 and parallel to the arranging direction of the microlenses 12. In FIG. 5, a left-right direction is parallel to the arranging direction of the microlenses 12.

In FIG. 5, a distance from a first principal plane H1a to a first focal plane FP1a is F1 (i.e., the front focal length F1). A distance from the first principal plane H1a to the object plane OP is expressed as SO.

A distance from a second principal plane H2b to a second focal plane FP2b of the second microlens 12b is F2. A distance from the second principal plane H2b to the imaging plane IP is expressed as SI.

Here, a difference between the distance SO and the distance LO is inversely proportional to a radius of curvature of a curved surface of the first microlens 12a on the object plane OP side. Further, a difference between the distance SI and the distance LI is inversely proportional to a radius of curvature of a curved surface of the second microlens 12b on the imaging plane IP side. In the lens array 1 of the first embodiment, radii of curvatures of the respective curved surfaces of the microlens 12 are very large, so that the difference between the distances SO and LO and the difference between the distances SI and LI are both negligible. Therefore, it can be understood that the distance SO is almost the same as the distance LO (i.e., SO≈LO), and the distance SI is almost the same as the distance LI (i.e., SI≈LI).

Further, principal light rays from respective points on the object plane OP are substantially parallel to the optical axis between the first and second microlenses 12a and 12b. In particular, a peripheral light ray of the light ray “RAY” passing the vicinity of the inner surface of the opening 13a is blocked by the light shielding member 13. Based on a similarity relationship of figures (i.e., two triangles) formed by the light ray RAY, the object plane OP and the first principal plane H1a of the first microlens 12a, a radius RV of a viewing field of the first microlens 12a is expressed as the following equation (2):

$$RV = RA \times \frac{LO - F 1}{F 1} \qquad ( 2 )$$

where RA is the radius of the cylindrical part of the opening 13a of the light shielding member 13 (see FIG. 3D).

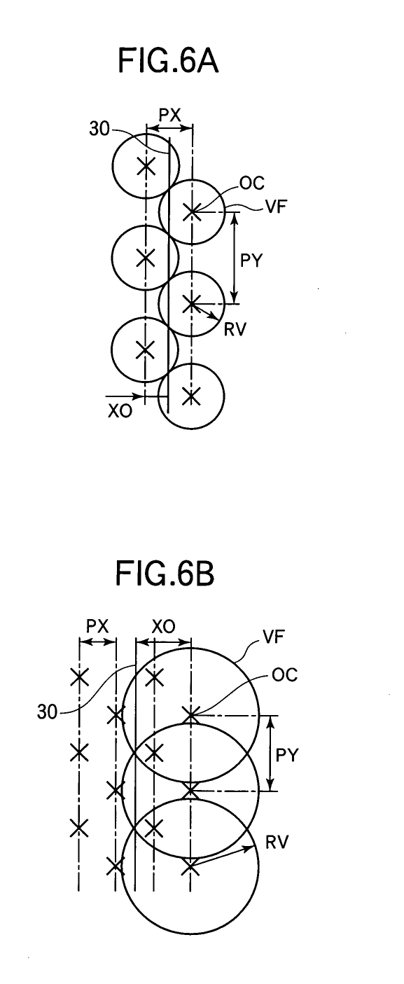

Next, a relationship between the arrangement of the microlenses 12 and the radii RV of viewing fields will be described with reference to FIGS. 6A and 6B. FIG. 6A shows the viewing fields and the optical axes of the microlenses 12 arranged in two rows, in relation to the LED array (the LED elements 30). Particularly, FIG. 6A shows the smallest radii RV of the viewing fields (VF) of the microlenses 12 in the case where each LED element 30 is disposed in the viewing field of at least one microlens 12, and where images of all LED elements 30 are formed on the surface of the photosensitive drum 41. In FIG. 6A, marks OC indicate intersections of the optical axes of the microlenses 12 and the object plane.

In this case, the radius RV of the viewing field 21 of the microlens 12 is expressed by the following equation (3):

$$RV = \sqrt{{( \frac{PX}{2} )}^{2} + {( \frac{PY}{4} )}^{2}} \qquad ( 3 )$$

where PY represents the arranging interval of the microlenses 12, and PX represents the interval between two rows in the direction perpendicular to the arranging direction of the microlenses 12.

Based on the equations (2) and (3), an operating condition of the lens array 1 is expressed as the following equation (4):

$$\sqrt{{( \frac{PX}{2} )}^{2} + {( \frac{PY}{4} )}^{2}} \leq RA \times \frac{LO - F 1}{F 1} \qquad ( 4 )$$

where F1 represents the focal length of the microlens 12, LO represents a distance from the lens array 1 to the object plane OP of the lens array 1, and RA represents the maximum distance from the optical axis of the microlens 12 to the inner surface of the opening 13a of the light shielding member 13.

FIG. 6B shows the viewing fields and optical axes of the microlenses 12 arranged in a plurality of rows (for example, four rows), in relation to the LED array (the LED elements 30). Particularly, FIG. 6B shows the smallest radii RV of the viewing fields (VF) of the microlenses 12 in the case where each LED element 30 is disposed in the viewing field of at least one microlens 12 of the outermost row.

In this case, the radius RV of the viewing field is expressed by the following equation (5):

$$RV = \sqrt{{( XO )}^{2} + {( \frac{PY}{4} )}^{2}} \qquad ( 5 )$$

where XO represents a distance from the LED element 30 to the optical axis of the microlens 12 of the outermost row in the direction perpendicular to the optical axis and also perpendicular to the arranging direction of the microlenses 12. PY represents the arranging interval of the microlenses 12 as described above.

From the equations (2) and (5), the operating condition for the lens array 1 is expressed as follows:

$$\sqrt{{( XO )}^{2} + {( \frac{PY}{4} )}^{2}} \leq RA \times \frac{LO - F 1}{F 1} \qquad ( 6 )$$

In the case where the microlenses 12 are arranged in one line, the operating condition of the lens array 1 will be obtained by assigning 0 to XO (i.e., XO=0) in the equation (6).

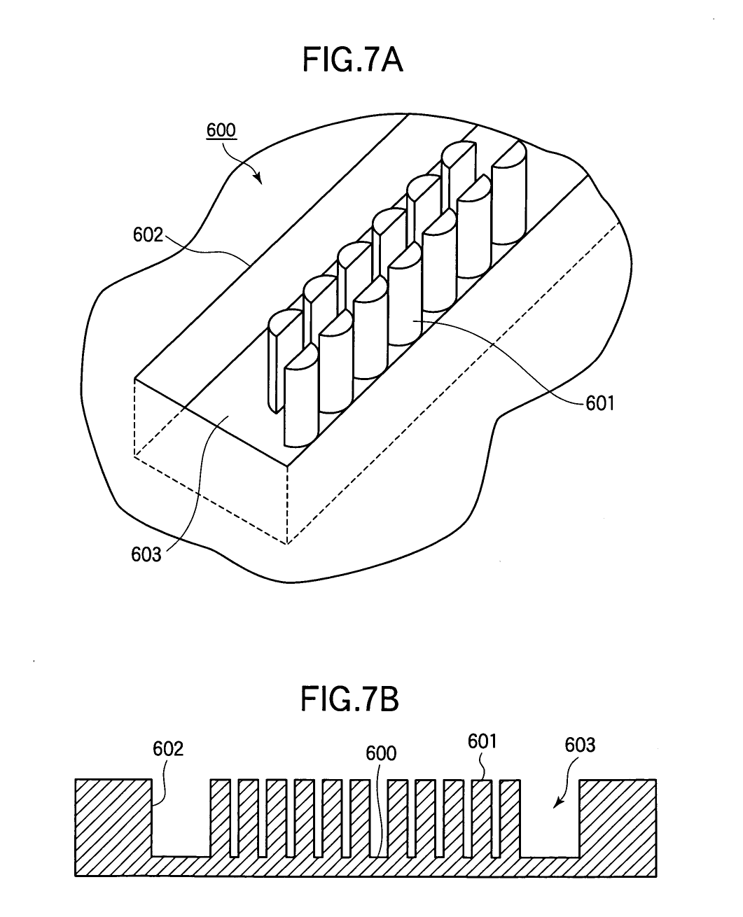

Next, a manufacturing method of the light shielding member 13 used in the lens array 1 according to the first embodiment will be described with reference to FIGS. 7A, 7B, 8, 9A, 9B and 9C.

FIG. 7A is a perspective view showing a lower mold (i.e., a mold or a first shape-forming member) used for molding the light shielding member 13. As shown in FIG. 7A, the lower mold 600 includes a frame body 602 that has a rectangular space 603, and a plurality of columnar members (i.e., columnar portions) 601 planted within the space 603 of the frame body 602.

The columnar members 601 are arranged in two rows (i.e., along two straight lines parallel to each other) according to the arrangement of the openings 13a. Each of the columnar members 601 is in the form of a cylinder which is cut by a plane parallel to an axis of the cylinder. The forms of the columnar members 601 correspond to the forms of the openings 13a of the light shielding member 13.

FIG. 7B is a sectional view of the lower mold 600 cut along a plane parallel to the arranging direction of the columnar members 601.

In FIG. 7B, the columnar members 601 are disposed in the space 603 of the frame body 602 so that the columnar members 601 are directed from a bottom of the space 603 toward an opening of the space 603. The positions of the columnar members 601 correspond to the positions of the openings 13a of the light shielding member 13.

The lower mold 600 is coupled with a not shown upper mold. In this state, a softened material is injected into a cavity (i.e., the space 603) of the frame body 602 by a molding machine (not shown), and the light shielding member 13 is formed.

In this embodiment, the lower mold 600 is made of tungsten carbide, and the light shielding member 13 is made of polycarbonate using injection molding.

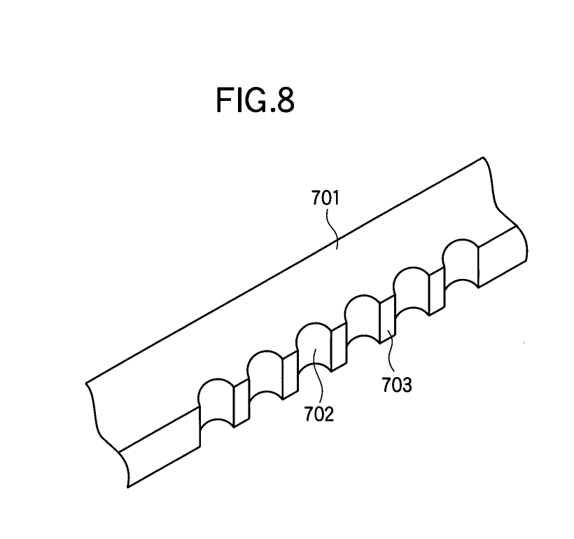

Next, a manufacturing method of the lower mold 600 will be described with reference to FIG. 8.

FIG. 8 is a perspective view showing a comb-shaped electrode 701 used for manufacturing the lower mold 600 by means of electrical discharge machining. The comb-shape electrode 701 (i.e., a die or a second shape-forming member) includes concave portions 702 and convex portions 703 which are arranged alternately. The concave portions 702 have shapes corresponding to the shapes of the columnar members 601. The convex portions 703 have shapes corresponding to the shapes of spaces between adjacent columnar members 601. Positions of the concave portions 702 correspond to the positions of the columnar members 601. The comb-shaped electrode 701 is made of electrically-conductive copper-tungsten and made by cutting work.

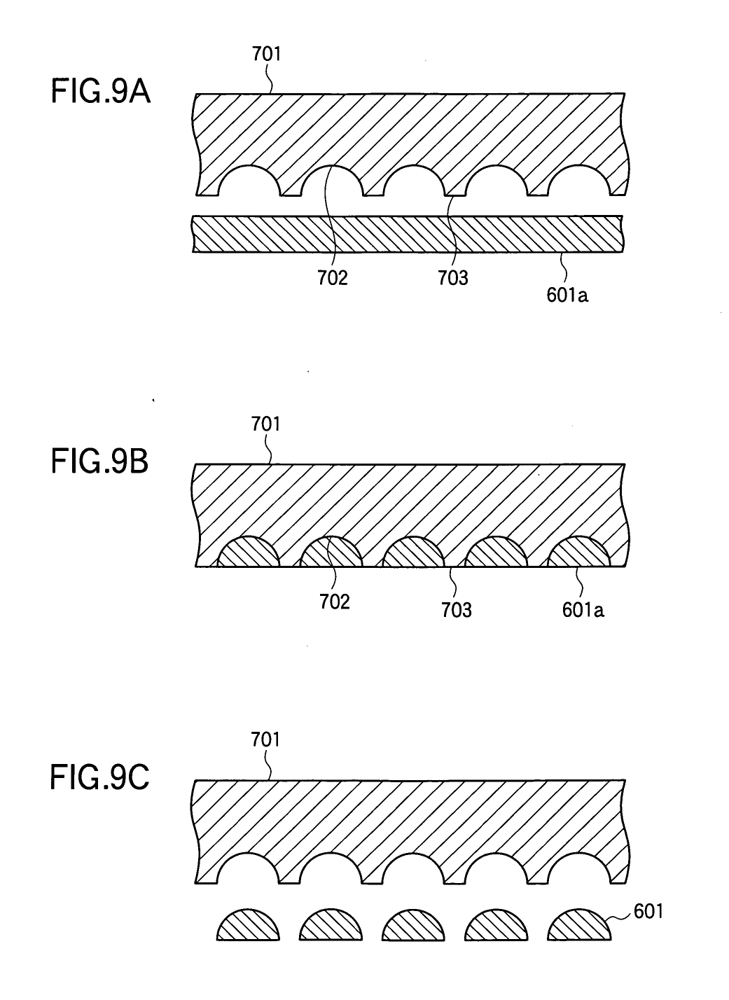

Next, a die-sinking electrical discharge machining for manufacturing the lower die 600 will be described with reference to FIGS. 9A, 9B and 9C.

As shown in FIG. 9A, a columnar-member-forming material 601a (i.e., which are to be machined into the columnar members 601) and the comb-shaped electrode 701 are placed inside an inner space of an electrical discharge machining apparatus filled with a machining liquid having insulation properties. The comb-shaped electrode 701 is provided so as to be movable in a direction toward the columnar-member-forming material 601a. In this embodiment, the columnar-member-forming material 601a is formed of tungsten carbide.

Next, the comb-shaped electrode 701 is applied with a voltage in the electrical discharge machining apparatus filled with the machining liquid, and the comb-shaped electrode 701 is moved in the direction toward the columnar-member-forming material 601a. When the comb-shaped electrode 701 is moved, a dielectric breakdown of the machining liquid occurs at portions where the comb-shaped electrode 701 and the columnar-member-forming material 601a are closest to each other, and spark discharge occurs at the portions.

A current flows from the portions where the spark discharge occurs, and the temperature of the portions reach several thousands of degrees centigrade, so that the columnar-member-forming material 601a is partially molten. Further, around the portions where the spark discharge occurs, the machining liquid evaporates and expands. Parts of the molten columnar-member-forming material 601a are dispersed by the vaporized and expanded machining liquid, so that the columnar-member-forming material 601a is machined.

As shown in FIG. 9B, according to the movement of the comb-shaped electrode 701 toward the columnar-member-forming material 601a, the portions of the spark discharge move, and the columnar-member-forming material 601a is machined into shapes of the columnar members 601.

Then, the movement of the comb-shaped electrode 701 is stopped, and the application of voltage to the comb-shaped electrode 701 is stopped.

When the machining of the columnar-member-forming material 601a into the columnar members 601 is completed, the comb-shaped electrode 701 is moved away from the columnar members 601 as shown in FIG. 9C.

In this embodiment, at least a part of the shape of the columnar shaped electrode 701 (i.e., the die) is transferred to at least a part of the lower mold 600 (i.e., the mold). Then, at least a part of the shape of the lower mold 600 is transferred to at least a part of the light shielding member 13. The columnar members 601 are formed using this die-sinking electrical discharge machining.

As described above, the columnar members 601 of the lower mold 600 are manufactured using the comb-shaped electrode 701, and the light shielding member 13 is manufactured using the lower mold 600.

According to the manufacturing method of the light shielding member 13 of the first embodiment, fine parts (more specifically, the openings 13a) of the light shielding member 13 can be formed with high accuracy. Therefore, the lens array 1 is capable of removing stray light that does not contribute to formation of an image. Further, it becomes possible to integrally form the light shielding member 13 having the openings 13a aligned with the optical axes of the microlenses 12.

Next, a description will be made of measurement results of MTF (Modulation Transfer Function) of the LED head 3 using the light shielding member 13 manufactured by the above described method according to the first embodiment. As a result of measurement, the MTF of the LED head 3 was greater than or equal to 80%. In this regard, the MTF indicates a resolution of the LED head 3 (the exposure device), i.e., a contrast of the image of the LED element 30 emitting the light. The MTF of 100% indicates that the imaging contrast is the highest, and that the LED element 30 (the exposure device) has the highest resolution. The small MTF indicates that the imaging contrast is low, and that the LED head 3 has low resolution.

When the maximum light intensity of the exposed image is expressed as EMAX, and the minimum light intensity of the adjacent two exposed images is expressed as EMIN, the MTF is defined as the following equation:

MTF={EMAX−EMIN}/(EMAX+EMIN)}×100(%)

On the measurement of the MTF, the exposed image at a distance LI (mm) from the end surface of the lens array 1 on the imaging plane side (i.e., the photosensitive drum 41 side) was taken by a microscopic digital camera. From the taken image, the distribution of the light intensity of the image of the LED element 30 was analyzed, and the above described MTF was calculated. Further, the LED head 3 having the LED elements 30 whose arranging interval PD is 0.0423 mm (PD=0.0423 mm) was used. The resolution of the LED head 3 was 600 dpi, i.e., 600 LED elements 30 were arranged per inch (1 inch is approximately 25.4 mm). The lens array 1 of the first embodiment was mounted to the LED head 3, and the LED elements 30 were alternately activated to emit light.

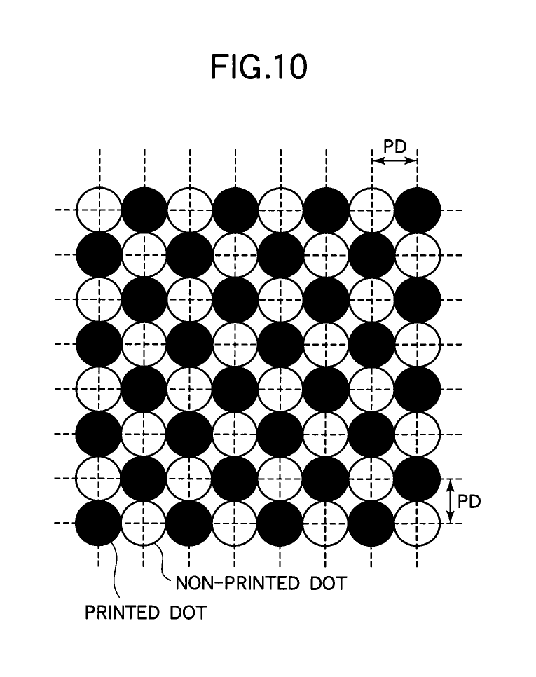

Next, images were printed on a media using a color LED printer (i.e., the printer 100) including the lens array 1 of the first embodiment, and the printed images were evaluated. As an evaluation pattern, dots were printed on alternate pixels throughout the printable area as shown in FIG. 10, and the image quality was checked. In FIG. 10, black dots indicate printed dots, and white dots indicate non-printed dots. As a result of evaluation, excellent images with no stripes or density irregularity were obtained.

In the first embodiment, the microlens 12 has a rotationally asymmetric high order aspheric surface. However, the shape of the microlens 12 is not limited to such a shape. For example, the microlens 12 can have a curved surface such as an anamorphic aspheric surface, a paraboloidal surface, an elliptical surface, a hyperboloidal surface or a conic surface.

Further, in the first embodiment, the shapes of the lens plates 11a and 11b are obtained by transferring the shapes of the metal mold to the resin. However, the shapes of the lens plates 11a and 11b can be formed using a resin mold, or can be formed by cutting work. Furthermore, although the lens plates 11a and 11b are composed of resin, the lens plates 11a and 11b can be formed of glass.

Furthermore, although the light shielding member 13 is formed of polycarbonate, the light shielding member 13 can be formed of other material. Although the light shielding member 13 is formed of injection molding, the light shielding member 13 can be formed of other molding method.

Moreover, it is also possible to use organic EL (electroluminescence) elements or semiconductor laser elements as a light emitting portion instead of the LED array with a plurality of LED elements 30. It is also possible that the exposure device includes a light emitting portion composed of a fluorescent lamp, a halogen lamp or the like and shutter elements composed of LED elements.

As described above, according to the first embodiment, the lower mold 600 is manufactured by the die-sinking electric discharge machining using the comb-shaped electrode 701 (as the die), and the light shielding member is manufactured by the injection molding using the lower mold 600. Therefore, the fine shapes (particularly, the openings 13a) can be formed with high accuracy.

To be more specific, since the light shielding member 13 is integrally formed so as to include the openings 13a, it is not necessary to combine a plurality of split parts of the light shielding member to form the openings as disclosed in the Patent Document No. 1. Therefore, it becomes possible to facilitate manufacturing of the light shielding member 13 with the accurately-formed openings 13a.

Since the lens array 1 uses the above manufactured light shielding member 13 (with the accurately-formed openings 13a), the lens array 1 can have a sufficiently high resolution.

Further, since the exposure device (the LED head 3) uses the lens array 1 of the first embodiment, the exposure device can form an image with a sufficient contrast.

Furthermore, since the image forming apparatus includes the exposure device using the lens array 1 of the first embodiment, the image forming apparatus can form an excellent image without stripes or density irregularity.

### Second Embodiment

Next, the second embodiment of the present invention will be described.

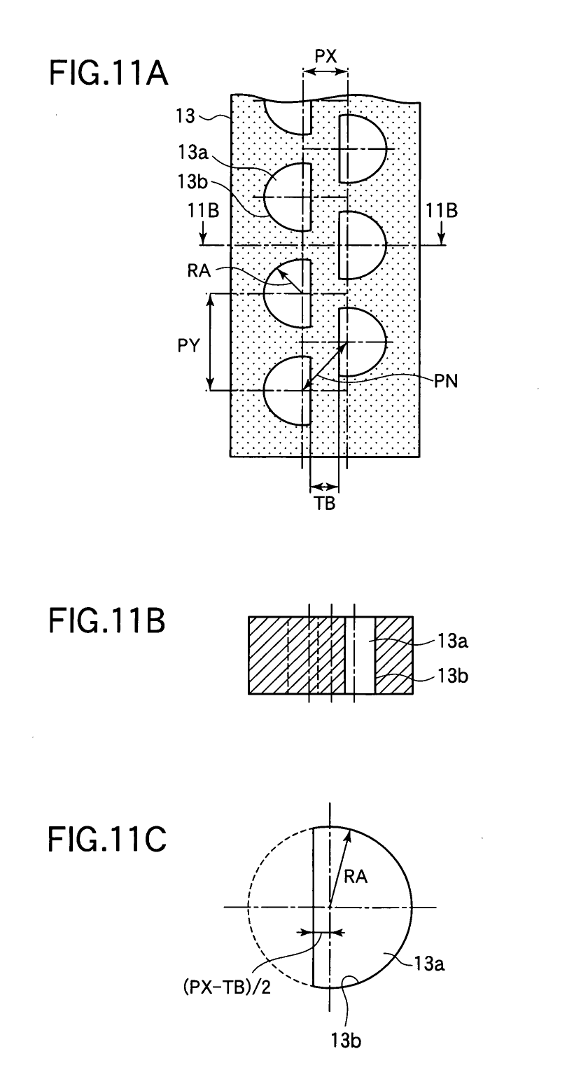

The second embodiment is different from the first embodiment in the structure of the light shielding member. The structure of the light shielding member according to the second embodiment will be described with reference to FIGS. 11A through 11C. Portions which are the same as those of the first embodiment are assigned the same reference numerals. FIG. 11A is a plan view showing the light shielding member. FIG. 11B is a sectional view showing the light shielding member taken along line 11B-11B in FIG. 11A. FIG. 11C is an enlarged plan view showing the openings of the light shielding member.

In FIG. 11A, a light shielding member 13 of the second embodiment has a light absorbing portion 13b formed on a part of the inner surface of each opening 13a. The light absorbing portion 13b absorbs the light emitted from the light emitting portion (the LED element 30) and incident on the inner surface of the opening 13a.

The light absorbing portion 13b has an arithmetic average roughness in a predetermined range as measured in a direction parallel to the optical axes of the microlenses 12.

In this embodiment, the light absorbing portion 13b has an arithmetic average roughness of 10 μm as measured in the direction parallel to the optical axes of the microlenses 12 according to JIS (Japanese Industrial Standard) B0601-1994.

The function of the lens array 1 of the second embodiment according to the second embodiment will be described.

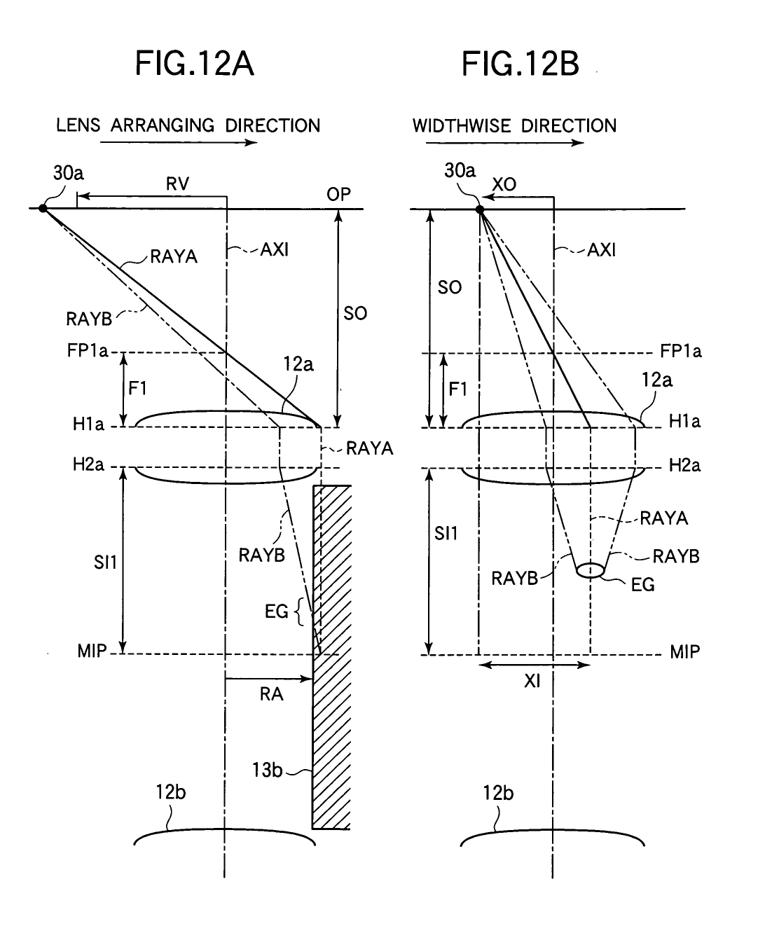

FIGS. 12A and 12B show the function of the lens array 1 according to the second embodiment. More specifically, FIG. 12A shows the first and second microlenses 12a and 12b that have aligned optical axes, a part of the opening 13a, the object 30a (i.e., the LED element 30) and light rays. In FIG. 12A, a left-right direction is parallel to the arranging direction of the microlenses 12, and a vertical direction is the direction of optical axes of the microlenses 12. In FIG. 12B, a left-right direction is parallel to a widthwise direction of the lens array 1 which is perpendicular to the arranging direction of the microlenses 12, and a vertical direction is the direction of optical axes of the microlenses 12. Further, in FIG. 12B, the right side corresponds to an outer side (i.e., the arcuate surface side of the opening 13a of the light shielding member 13) of the lens array 1 in the widthwise direction.

As shown in FIG. 12A, the light ray RAYB is emitted by the object 30a (the LED element 30), is incident on the first microlens 12a as the peripheral light ray, and forms an image EG on the inner surface of the opening 13a at a position between the intermediate imaging plane MIP and the first microlens 12a. This position is at a distance XI from the object 30a in the direction perpendicular to the arranging direction of the microlenses 12 and perpendicular to the optical axes of the microlenses 12 as shown in FIG. 12B.

If the light absorbing portion 13b is not provided, the light ray forming the image EG is reflected and scattered at the inner surface of the opening 13a and is incident on the second microlens 12b. Then, the light ray reaches the imaging plane IP, so as to increases a light intensity at a position on the imaging plane IP other than the image 30c of the LED element 30. As a result, a flare may occur, which may cause reduction in the resolution of the lens array.

However, according to the second embodiment, the light ray forming the image EG is absorbed by the light absorbing portion 13b, and therefore it becomes possible to prevent the flare that may cause reduction in the resolution of the lens array 1.

Next, the position of the image EG will be described with reference to FIGS. 12A and 12B.

As shown in FIG. 12B, if the light shielding member 13 is neglected, the light ray RAYA (as a principal light ray) emitted by the object 30a crosses with the optical axis AXI at the first focal plane FP1a, is incident on the first microlens 12a, and passes a position at a distance XI from the object 30a.

From FIG. 12B, based on the similarity relationship of the figures (two triangles) formed by the principal light ray RAYA, the optical axis AXI, the object plane OP and the first principal plane H1a, and based on the relationship SO≈LO, the distance XI (where the image EG is formed) is expressed as follows: XI=LO×XO/(LO−F1)

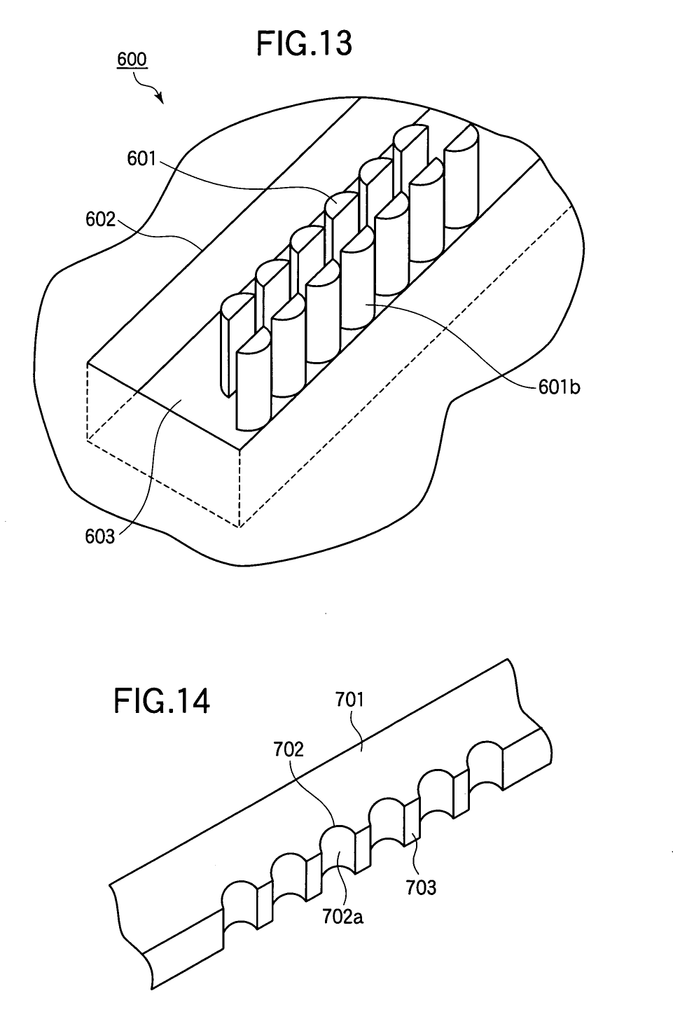

FIG. 13 is a perspective view showing a lower mold (as a mold, or a first shape-forming member) used for molding the light shielding member 13. As shown in FIG. 13, the lower mold 600 includes a frame body 602 and a plurality of columnar members 601 planted within the space 603 in the frame body 602. Roughened portions 601b are formed on the surfaces of the columnar members 601. The shapes of the roughened portions 601b are transferred to the light absorbing portions 13b of the light shielding member 13. Therefore, positions where the roughened portions 601b are formed correspond to the positions where the light absorbing portions 13b are formed.

An arithmetic average roughness of the roughened portions 601b corresponds to an arithmetic average roughness of the light absorbing portions 13b. When the arithmetic average roughness of the roughened portions 601b increases, the arithmetic average roughness of the light absorbing portions 13b also increases.

In this embodiment, the shapes and roughness of the roughened portions 601b of the columnar members 601 are transferred to the light absorbing portions 13b of the light shielding member 13.

Next, a manufacturing method of the lower mold 600 according to the second embodiment will be described with reference to FIG. 14.

FIG. 14 is a perspective view showing the comb-shaped electrode 701 (as an electrode, a die, or a second shape-forming member) used for manufacturing the lower mold 600 using a discharge machining.

In FIG. 14, the comb-shaped electrode 701 has concave portions 702 and convex portions 703 that are alternately disposed. As described in the first embodiment, shapes of the concave portions 702 correspond to shapes of the columnar members 601, and shapes of the convex portions 703 correspond to shapes of spaces between adjacent columnar members 601. Position of the concave portions 702 correspond to positions of the columnar members 601 of the lower frame 600.

Roughened portions 702a are formed on the concave portions 702. Shapes of the roughened portions 702a are transferred to the roughened portions 601b of the columnar members 601 of the lower mold 600. Therefore, positions where the roughened portions 702a are formed corresponding to positions where the roughened portions 601b of the columnar members 601 are formed.

An arithmetic average roughness of the roughened portions 702a corresponds to an arithmetic average roughness of the roughened portions 601b. When the arithmetic average roughness of the roughened portions 702a increases, the arithmetic average roughness of the roughened portions 601b also increases.

In this embodiment, the shapes and roughness of the roughened portions 702a of the concave portions 702 are transferred to the roughened portions 601b of the columnar members 601. The roughened portions 702a are formed by cutting work.

Next, a description will be made of experimental results on the light absorbing portion 13b of the shielding member 13 formed by the injection molding using the lower mold 600.

Several lens arrays 1 having light absorbing portions 13b with different roughness were manufactured, using the roughened portions 601b and the roughened portions 702a formed to have various different roughness. Evaluations of these lens arrays 1A were performed using the pattern shown in FIG. 10. As a result of evaluation, when the arithmetic average roughness of the light absorbing portions 13b was greater than or equal to 2 μm as measured in the direction parallel to the optical axes of the microlenses 12, the flare (that causes reduction in the resolution of the image) was sufficiently prevented, and the lens array 1 with high resolution was obtained.

However, when the arithmetic average roughness of the roughened portion 601b was increased (more specifically, to be greater than 20 μm) by increasing the roughness of the roughened portion 702a, the light shielding member 13 could not be taken out of the lower mold 600. Therefore, the light shielding member 13 having the light absorbing portion 13b with the roughness greater than 20 μm could not be formed.

Therefore, the preferable range of the arithmetic average roughness of the light absorbing portion 13b is from 2 μm to 20 μm.

In general, as an arithmetic average roughness of a surface of a mold increases, a resistance between a molded article and the mold increases when the molded article is to be taken out of the mold, and in such a case the shape of the mold is not accurately transferred to the molded article. If the arithmetic average roughness of the surface of the mold further increases, the molded article can not be taken out of the mold.

As described above, according to the second embodiment, the light absorbing portions 13b are formed on the inner surfaces of the openings 13a of the light shielding member 13, and the light absorbing portions 13b absorb incident lights. Therefore, it becomes possible to prevent the reflection and scattering of the light (for forming an image by the function of the lens array 1) at the inner surfaces of the openings 13a. Therefore, in addition to the advantages of the first embodiment, it becomes possible to achieve the lens array with sufficient resolution.

### Third Embodiment

In the first and second embodiment, the lens array according to the present invention is applied to the printer as the image forming apparatus. In contrast, in the third embodiment, the lens array according to the present invention is applied to a reading apparatus.

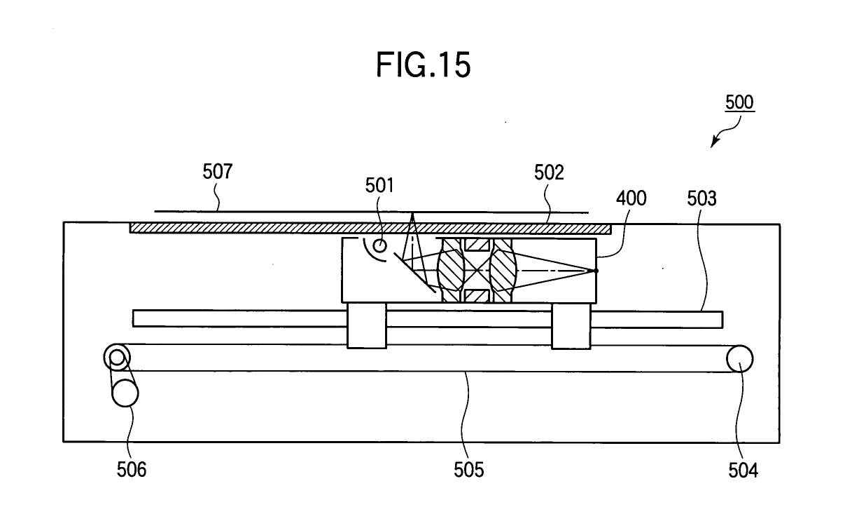

FIG. 15 is a schematic view showing a configuration of the reading apparatus employing the lens array according to the first or second embodiment. In FIG. 15, portions that are the same as those of the first or second embodiment are assigned the same reference numerals, and duplicate explanations are omitted.

In FIG. 15, a numeral 500 indicates a scanner as a reading apparatus that reads a manuscript 507 and generates electric data. The scanner 500 includes a reading head 400, a lamp 501, a manuscript table 502, rails 503, pulleys 504, a driving belt 505, a motor 506 or the like. The reading head 400 is illuminated by the lamp 501 as an illumination unit. The reading head 400 takes in the lights reflected by the surface of the manuscript 507, and converts the images into the electric data. The lamp 501 is disposed so that the light emitted therefrom is reflected by the surface of the manuscript 507 and incident on the reading head 400.

The manuscript 507 from which the electric data is produced is placed on the manuscript table 502. The manuscript table 502 is formed of a material that transmits a visible light.

The rail 503 is disposed on the lower side of the manuscript table 502, and supports the reading head 400 so that the reading head 400 is movable. A part of the reading head 400 is connected to the driving belt 505 stretched around a plurality of pulleys 504. The reading head 400 is moved along the rail 503 by the driving belt 505 driven by the motor 506.

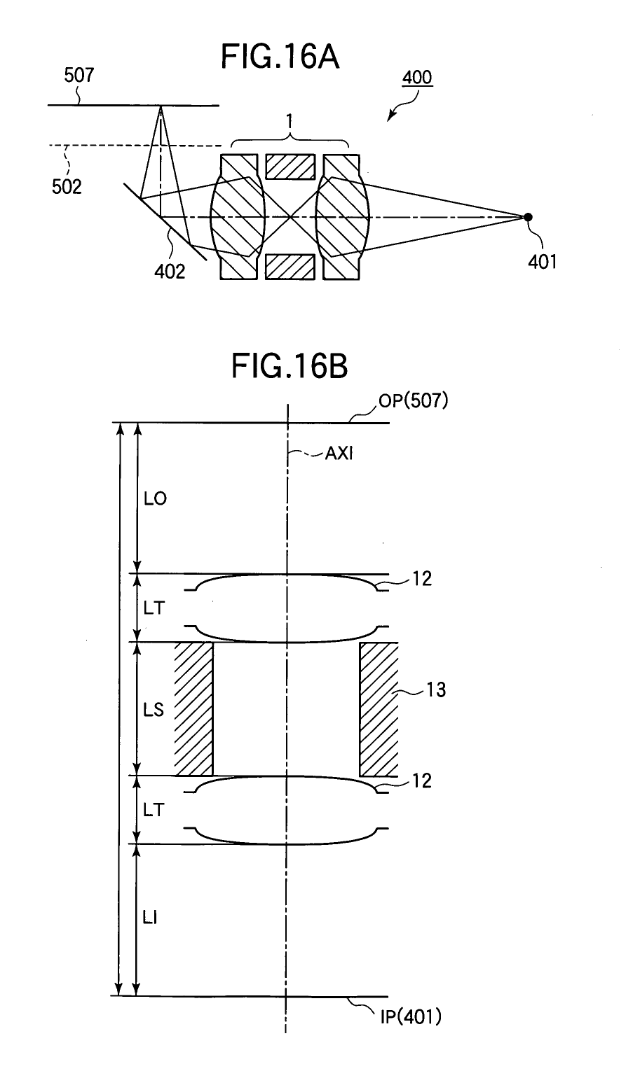

Next, a configuration of the reading head 400 according to the third embodiment will be described with reference to FIGS. 16A and 16B.

FIG. 16A shows the configuration of the reading head 400. In FIG. 16A, the reading head 400 includes the lens array 1, a line sensor 401 and a mirror 402. The mirror 402 bends a light path of the light from the manuscript 507, and reflects the light toward the lens array 1.

The line sensor 401 includes a plurality of light receiving elements which are linearly arranged at predetermined intervals PR. The line sensor 401 converts images of the manuscript 507 (formed by the lens array 1) into electric signals.

FIG. 16B shows a relationship between the object plane OP (i.e., the manuscript 507) and the reading head 400 according to Embodiment 3. The configuration of the lens array 1 is the same as the lens array 1 according to the first or second embodiment.

In the third embodiment, the line sensor 401 has a resolution of 600 dpi, i.e., 600 light receiving elements are arranged per inch (1 inch is approximately 25.4 mm). In other words, the interval PR between the light receiving elements is 0.0423 mm.

Next, an operation according to the third embodiment will be described with reference to FIG. 15. In FIG. 15, when the lamp 501 is turned on, the surface of the manuscript 507 is exposed with the light. The light reflected by the surface of the manuscript 507 is taken in by the reading head 400. The motor 506 drives the driving belt 505, and the reading head 400 with the lamp 501 moves in the left-right direction in FIG. 15, so that the reading head 400 takes in the light reflected by the entire surface of the manuscript 507.

An operation of the reading head 400 will be described with reference to FIG. 16A. The light reflected by the manuscript 507 passes the manuscript table 502, is reflected by the mirror 402, and is incident on the lens array 1. The image of the manuscript 507 is formed on the line sensor 401 by the lens array 1. The line sensor 401 converts the image of the manuscript 507 into electric signals.

Next, a description will be made of evaluation test on the reading apparatus according to the third embodiment. In the evaluation test, image data was formed from the manuscript 507. The manuscript 507 had the pattern shown in FIG. 10 corresponding to 600 dpi in which dots were alternately formed on pixels arranged at the intervals PD of 0.0423 mm on the entire printable area of a media. As a result of evaluation, an excellent image data being the same as the manuscript 507 was obtained.

In the third embodiment, the scanner has been described as an example of the reading apparatus. However, the third embodiment is applicable to a sensor or switch that converts optical signals into electric signals, and is also applicable to an input-output device, a biometric identification device or a dimension measurement device using such sensor or switch.

As described above, according to the third embodiment, the reading apparatus employs the lens array according to the first or second embodiment, and therefore excellent image data being the same as the manuscript can be obtained.

### Fourth Embodiment

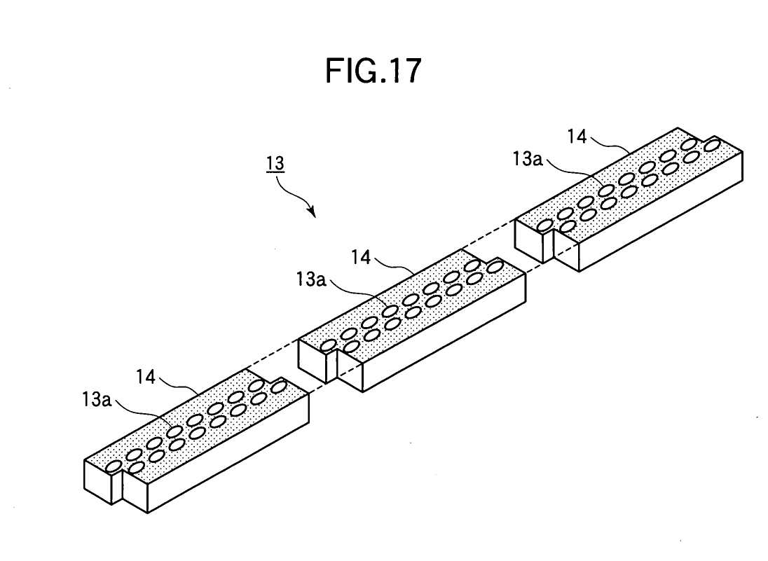

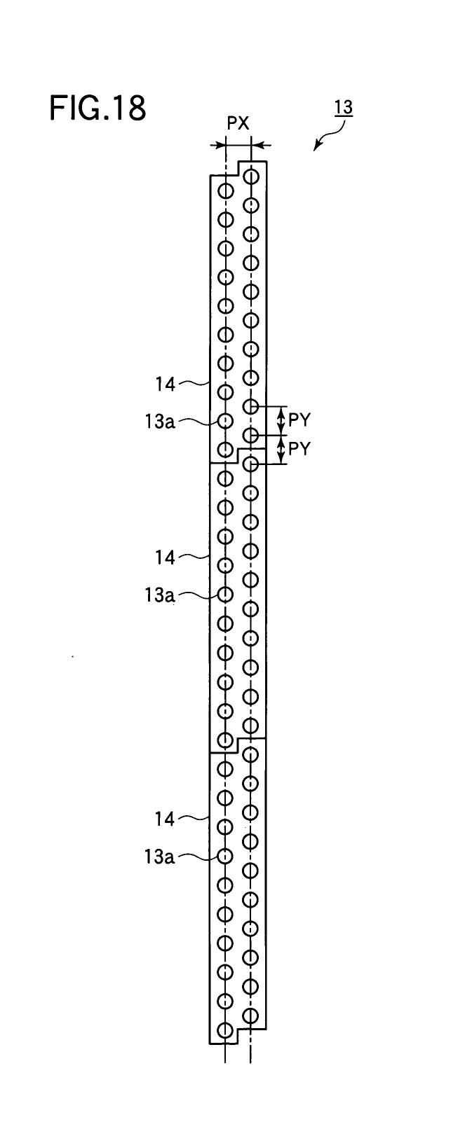

The fourth embodiment is different from the first and second embodiments in the structure of the light shielding member. FIGS. 17 and 18 are an exploded perspective view and a plan view showing the light shielding member according to the fourth embodiment. In FIGS. 17 and 18, portions that are the same as those of the first or second embodiment are assigned the same reference numerals, and duplicate explanations are omitted.

In FIG. 17, the light shielding member 13 is formed by connecting a plurality of light shielding blocks (i.e., light shielding parts) 14. Each light shielding block 14 has a plurality of openings 13a.

As shown in FIG. 18, each of the light shielding blocks 14 has a plurality of openings 13a having a cylindrical shape. Each opening 13a has a circular shape with no cutout portion in a cross section perpendicular to the optical axes of the microlenses 12. In each light shielding block 14, the openings 13a are arranged in two rows and arranged alternately in a zigzag pattern. In each row, the openings 13a are arranged at the intervals PY. The interval between two rows in the direction perpendicular to the arranging direction of the microlenses 12 is PX.

The light shielding blocks 14 (each of which includes the openings 13a arranged as described above) are connected in the direction parallel to the arranging direction of the openings 13a, so that the light shielding member 13 is formed.

Throughout the light shielding member 13 in which the light shielding blocks 14 are connected, the openings 13a are arranged at the intervals PY in each row, and the interval between two rows in the direction perpendicular to the arranging direction of the openings 13a is PX.

As is the case with the light shielding members 13 of the first and second embodiments, each of the light shielding blocks 14 is integrally formed so as to include a plurality of openings 13a.

The lens array using the light shielding member according to the fourth embodiment, the LED head using the lens array, the exposure device using the LED head, the image forming apparatus using the exposure device, and the reading apparatus using the lens array are the same as those described in the first and second embodiments, and therefore explanations thereof are omitted.

The lens array 1 of the fourth embodiment is applicable to the image forming apparatus as described in the first and second embodiments, and is also applicable to the reading apparatus as described in the third embodiment.

Further, it is also possible that the opening 13a of the fourth embodiment has a circular shape with a cutout portion (in a cross section perpendicular to the optical axis) as is the case with the opening 13a of the first or second embodiment. Further, it is also possible that the opening 13a of the first or second embodiment has a circular shape with no cutout portion (in a cross section perpendicular to the optical axis) as is the case with the opening 13a of the fourth embodiment.

As described above, according to the fourth embodiment, the light shielding member 13 is formed of a plurality of light shielding blocks (i.e., light shielding parts) 14, and therefore each light shielding block 14 has relatively small longitudinal size (length). Therefore, when the light shielding block 14 is formed of the injection molding, a contraction amount of the light shielding block 14 is small, and therefore warping or distortion of the light shielding block 14 can be suppressed. Accordingly, in addition to the advantages of the first to third embodiments, the accuracy in the positions and shapes of the openings 13a can be enhanced.

While the preferred embodiments of the present invention have been illustrated in detail, it should be apparent that modifications and improvements may be made to the invention without departing from the spirit and scope of the invention as described in the following claims.

What is claimed is:

1. A lens array comprising:
a plurality of lens groups each of which includes a plurality of lenses arranged in a direction perpendicular to optical axes of said lenses; said lens groups being disposed so that said lenses of said respective lens groups have aligned optical axes, and
a light shielding member provided between said lens groups, said light shielding member having a plurality of apertures with substantially cylindrical shapes through which said optical axes of the respective lenses pass,
wherein said light shielding member is integrally formed so as to include a plurality of said apertures.

2. The lens array according to claim 1, wherein, in a cross section perpendicular to said optical axes, each of said apertures has a circular shape with a cutout portion.

3. The lens array according to claim 1, wherein said light shielding member is formed by molding.

4. The lens array according to claim 3, wherein a first shape-forming member is used in said molding,
wherein a shape of at least a part of said first shape-forming member is transferred to said light shielding member, and
wherein said first shape-forming member is formed using a second shape-forming member, a shape of at least a part of said second shape-forming member being transferred to said first shape-forming member.

5. The lens array according to claim 4, wherein at least a part of said first shape-forming member is machined by means of die-sinking electrical discharge machining using said second shape-forming member.

6. The lens array according to claim 4, wherein said second shape-forming member is composed of a comb-shaped electrode having concave portions and convex portions which are alternately arranged,
wherein said first shape-forming member includes columnar portions machined by means of die-sinking electrical discharge machining using said comb-shaped electrode, and
wherein said apertures of said light shielding member is formed using said columnar portions.

7. The lens array according to claim 1, wherein a light absorbing portion is formed on at least a part of an inner surface of said aperture, said light absorbing portion absorbing light.

8. The lens array according to claim 7, wherein said light shielding member is formed by molding using a first shape-forming member, and
wherein a shape of at least a part of said first shape-forming member with a roughed portion is transferred to said light shielding member.

9. The lens array according to claim 7, wherein said light absorbing portion has an arithmetic average roughness greater than or equal to 2 μm as measured in a direction of said optical axes.

10. The lens array according to claim 7, wherein said light absorbing portion has an arithmetic average roughness in a range from 2 μm to 20 μm as measured in said direction of said optical axes.

11. The lens array according to claim 1, wherein said light shielding member is formed of a plurality of light shielding parts which are connected to each other, and
wherein each of said light shielding parts is integrally formed so as to include a plurality of said apertures.

12. The lens array according to claim 10, wherein said light shielding parts are connected to each other in a direction in which said apertures are arranged.

13. An LED head comprising said lens array according to claim 1.

14. An exposure device comprising said lens array according to claim 1.

15. An image forming apparatus comprising said lens array according to claim 1.

16. A reading apparatus comprising said lens array according to claim 1.
